(19) United States
(12) Patent Application Publication
(10) Pub. No.: US 2011/0180468 A1
(43) Pub. Date: Jul. 28, 2011

(54) CLEAN FILTER HOUSING

(76) Inventors: Michael Foley, Vaudreuil (CA); Sylvain Champoux, Laval (CA); Steve Leduc, Laval (CA); Jonathan George, Laval (CA); Ilko Paunov, Laval (CA)

(21) Appl. No.: 12/692,100

(22) Filed: Jan. 22, 2010

(51) Int. Cl. F01M 11/03; B08B 7/00

(52) U.S. Cl. 210/167.04; 210/167.08; 137/15.01

(57) ABSTRACT

A filter housing providing improved cleanliness is provided. In one embodiment, the filter housing includes a body, a cover plate and a clean fluid manifold assembly. The body has a first plenum defined therein which is configured to accommodate multiple filter elements. The clean fluid manifold having a recess and plurality of index tubes. The recess bounds a second plenum, wherein surfaces of the recess have been machined, or otherwise have had surface material removed to provide a smooth, clean and contamination free surface. The plurality of index tubes have a first end coupled to the clean fluid manifold and a second end extending into the first plenum, the second end of the index tube configured to engage with a filter element.

### BACKGROUND OF THE INVENTION

1. Field of the Invention

The present invention generally relates to a filter housing that accommodates multiple filter elements, and more particularly, embodiments described herein relate to a filter housing that accommodates multiple filter elements suitable for high volume, high pressure, filtration applications.

2. Description of the Related Art

Generally, filter systems operate to filter out contaminants, unwanted particles, and debris from fluids for use in a downstream apparatus or process. Filter systems and apparatuses are often used in conjunction with engine systems found in vehicles such as automobiles, trains, ships and aircraft to ensure consistent operating conditions. Filter systems often have functional requirements such as minimum levels of cleanliness for the filtrate and internal pressure ratings.

A typical conventional filter apparatus 150, as illustrated in FIG. 1, comprises a filter housing 100, having a first plenum 106 and a second plenum 108, and a plurality of filter elements 102. The filter apparatus 150 is generally suitable for filtering fluids for use by a downstream device or process that uses filtered fluid. “Unfiltered” fluid enters the first plenum 106 of the housing 100 through an inlet port 104, whereupon the fluid flows through the plurality of filter elements 102 arranged for flow in parallel. The “unfiltered” fluid flows from the outside of each element through the filter media of each filter element which separates and retains contaminants and particles from the fluid on or in the filter media. The now-filtered fluid reaches the inner core of each of the filtering elements from which the fluid flows towards and into the second plenum 108 of the housing 100. The first plenum 106 and the second plenum 108 of the filter housing 100 is separated by a separation element 110, such as diaphragm plate or tubesheet, which may be welded or otherwise attached to the housing 100. The filtered fluid may flow through the separation 110 by a variety of mechanisms, such as index tubes 112 welded or otherwise attached to the separation 110 or tubesheet holes which could incorporate a seal to separate the filtered fluid from the unfiltered fluid contained in the first plenum 106. The filtered fluid flows out of the filter elements 102 and combines in the second plenum 108. The filtered fluid exits the second plenum 108 through an outlet port 116 to bring the filtered fluid to a downstream device or process.

In some filter applications, for example filtering lubrication oil in modern diesel engines, the filter housing must have a high level of cleanliness to prevent contamination of the filtered fluid prior to exiting the housing. In such cases, the major sources of contamination of the filtered fluid are particles which can detach from the interior surfaces of the materials used to fabricate the filter housing, and particles generated or introduced into the housing during the manufacturing of the filter housing. Particles which can detach from the interior surfaces of the housing materials include, but are not limited to, casting surface inclusions, rust or other corrosion products, scale from hot rolled metal surfaces and products added to housing materials to protect them during shipment and storage. Particles generated during the manufacturing process include but are not limited to machining chips, grinding dust, weld spatter, weld flux, abrasive blasting agents and material removed from surfaces by such blasting agents. Some of these contaminants may be magnetised by manufacturing operations and may adhere to other magnetic materials, or, alternatively, the housing may become magnetised during manufacture and attract magnetic contaminants which adhere to it. Contaminants may also be introduced from the environment, such as from ambient dust, smoke, condensation, precipitates, etc. These contaminants may be removed by such techniques as abrasive blasting, chipping, grinding, brushing, washing, flushing, pickling, passivating, and vacuuming. The challenge with these techniques is in ensuring that any particle that could detach from the housing surface during operation is removed by the cleaning process and in ensuring that all loose or potentially loose products in the second chamber of the filter housing are actually removed by the cleaning process. Conventional clean fluid plenum designs and cleaning processes have not demonstrated consistently reliable results.

A related problem is that the designs of clean fluid plenums, such as the second plenum 108 of the conventional filter housing 100 illustrated in FIG. 1, by their closed and relatively inaccessible nature, do not facilitate cleaning and are difficult to inspect for cleanliness. The conventional clean fluid plenums are generally enclosed, wherein the major access to the plenum being through an outlet port connection or possibly an access cover for a filter bypass valve where a bypass valve is used. As a result, the interior surfaces of the housing bounding these conventional clean fluid plenums are difficult to clean and inspect for cleanliness, resulting in an undesirable uncertainty of the risk of introduction of contaminants and/or particles into the filtered fluid during operation.

Thus, there is a need for an improved filter apparatus.

### SUMMARY OF THE INVENTION

A filter housing providing improved cleanliness is provided. In one embodiment shown in FIG. 2, the filter housing includes a body, a cover plate and a manifold block assembly. The body has a first plenum defined therein which is configured to accommodate multiple filter elements. The manifold block assembly includes a manifold block having a recess, such as a cavity, and a plurality of index tubes. The recess bounds a second fluid plenum, wherein surfaces of the recess exposed to the second plenum are machined to provide smooth clean surfaces for cleaning and inspection. The plurality of index tubes have a first end coupled to the manifold block and a second end extending into the first plenum, the second end of the index tube configured to engage with a filter element.

In another embodiment, the filter housing includes a cover plate, an end cap and a sleeve defining a body having an internal diameter of at least 6 inches and a pressure rating of at least 11 psig. A first plenum is defined within the body and separated from a second plenum by the end cap. A surface of the end cap exposed to the second plenum has a minimum surface finish of about 250 RMS or smoother. A plurality of index tubes provide fluid passages between the first plenum and the second plenum. Each index tube has a first end coupled to the end cap and a second end extending into the first plenum. The second end of the index tube is configured to engage a filter element.

In yet another embodiment of the present invention, one or more index tubes connect multiple filter housings to a clean fluid manifold having a clean fluid plenum. The interior surfaces of the clean fluid plenum are machined to provide smooth clean surfaces for cleaning and inspection. Each filter housing contains one or more filter elements which engages an index tube or tubes that projects through a closed end of the filter housing.

### BRIEF DESCRIPTION OF THE DRAWINGS

The teachings of the present invention can be readily understood by considering the following detailed description in conjunction with the accompanying drawings, in which:

FIG. 1 depicts a conventional filter housing;

FIG. 2 is a cut-away view of one embodiment of a filter housing;

FIG. 3 is a partial end view of the filter housing depicted in FIG. 2;

FIG. 4 is an enlarged sectional view of the filter housing depicted in FIG. 2;

FIGS. 4A-C are details of portions of the sectional view of FIG. 4;

FIG. 5 is a end view of one embodiment of a manifold block assembly;

FIG. 6 depicts an embodiment of the manifold block assembly of FIG. 2 illustrated with capped passages or index tubes and outlet pipe;

FIG. 7 in a cut away view of another embodiment of the filter housing;

FIG. 8 is a cut-away view of another embodiment of a filter housing;

FIG. 9 is a cut-away view of another embodiment of a filter housing;

FIG. 10 is a partial sectional view of the filter housing depicted in FIG. 9;

FIG. 11 is a cut-away view of another embodiment of a filter housing;

FIG. 12 is a cut-away view of another embodiment of a filter housing; and

FIG. 13 is a cut-away view of yet another embodiment of a filter housing.

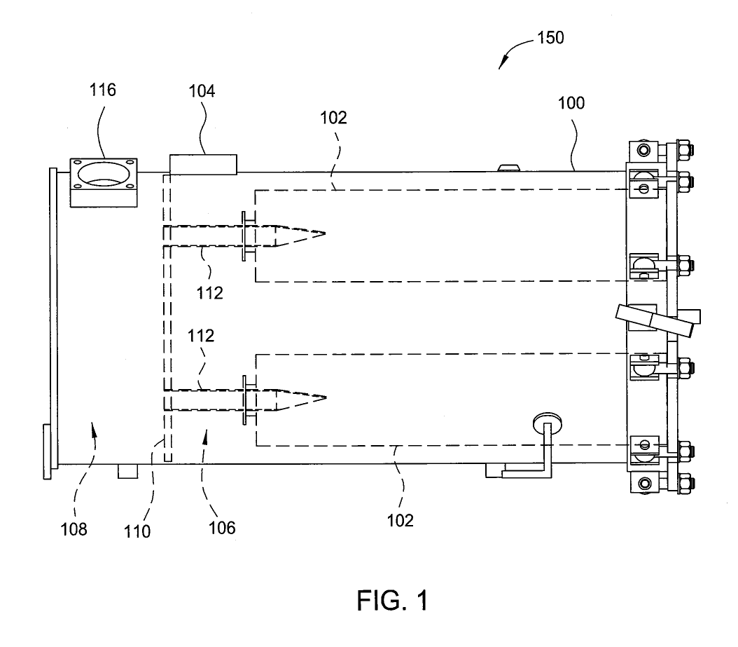

To facilitate understanding, identical reference numerals have been used, where possible, to designate identical elements that are common to the figures. It is contemplated that elements and features of one embodiment may be beneficially incorporated in other embodiments without further recitation.

It is to be noted, however, that the appended drawings illustrate only exemplary embodiments of this invention and are therefore not to be considered limiting of its scope, for the invention may admit to other equally effective embodiments.

### DETAILED DESCRIPTION

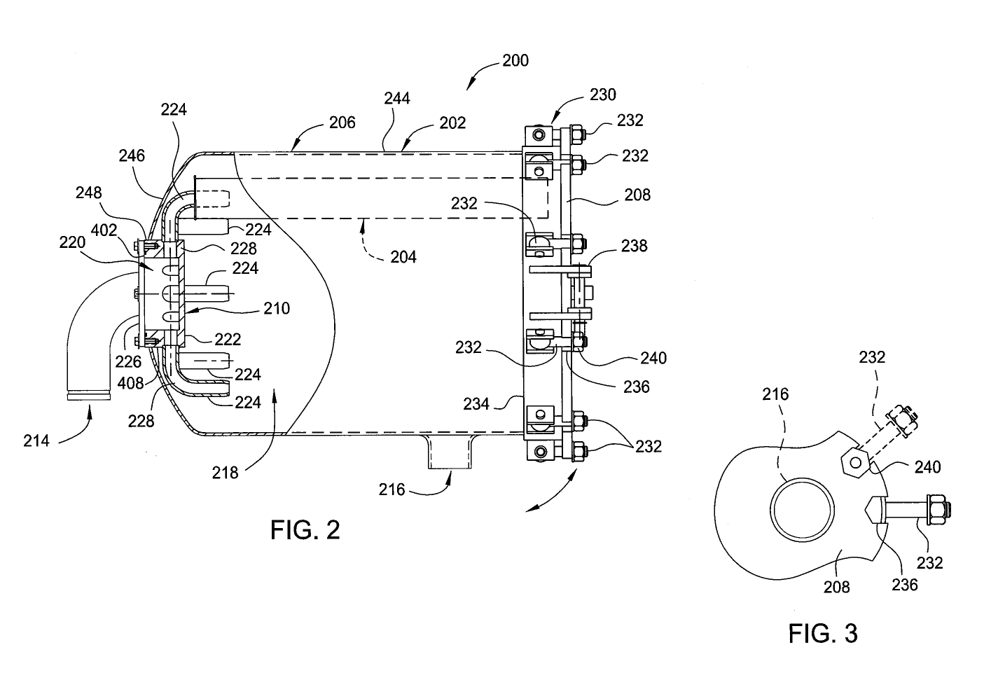

FIG. 2 is one embodiment of a filter apparatus 200 according to one embodiment of the invention. The filter apparatus 200 includes a housing 202 which accommodates a plurality of filter elements 204 disposed therein. Only one filter element 204 is shown in the embodiment depicted in FIG. 2 to avoid drawing clutter and to promote clarity. The filter elements 204 are selected to be compatible with the fluid filtered by the filtering apparatus and may be selected to provide a predefined pressure drop and filtering efficiency commensurate with the desired use of the filter apparatus 200 as known in the art. In one embodiment, the filter element 204 is suitable for filtering engine lube oil at a temperature range of 35 to 250 degrees Fahrenheit, utilizing a pressure drop of up to 100 psid at a flow of 100 gallons per minute while providing a nominal filtering efficiency of 10 microns. It is contemplated that filters having other performance characteristics may be utilized for other applications.

The housing 202 includes a body 206, a cover 208 and a manifold block assembly 210 which confine a first or unfiltered fluid plenum 218 in which the filter elements 204 reside. The body 206 is sealingly coupled to the manifold block assembly 210 by welds or other suitable leak-tight fastening arrangement. The cover 208 is removably coupled to the body 206 by a plurality of securing mechanisms 230. The securing mechanisms 230 may be bolts, clamps, fasteners, threads or other arrangement suitable for removably securing the cover 208 to the body 206. The securing mechanisms 230 may be coupled to a hoop or shell ring 234 that is welded to the body 206 for structural strength and ease of assembly. In the embodiment depicted in FIG. 2, the securing mechanism 230 includes a plurality of toggle bolts 232 coupled to the body 206, which may be rotated to engage with slots 236 formed in the cap plate or cover 208. A plurality of nuts 240 may be threaded on the toggle bolts 232 to secure the cover 208 to the body 206. A gasket or other suitable seal (not shown) is disposed between the cover 208 and the body 206 to prevent fluid leakage escaping the unfiltered fluid plenum 218. In one embodiment, a hinge 238 may be provided to secure the cover 208 to the body 206.

The body 206 can be fabricated from steel or other material compatible with the fluid to be filtered at the operational pressure and temperature conditions. Examples of other suitable materials may include, but are not limited to, cast iron, steel, stainless steel, aluminum, plastic, and fiber-reinforced composites. In one embodiment, the body is sized to accommodate at least two, four-inch diameter filter elements 204. In another embodiment, the body 206 has a diameter of at least 6 inches and a pressure rating of at least 11 psig while at a temperature of 35 to 250 degrees Fahrenheit. In yet another embodiment, the body 206 is sized such that the unfiltered fluid plenum 218 has a volume (excluding the filter elements 204 disposed therein) of at least 0.2 cubic feet while having a pressure rating of at least 11 psig. In large diesel engine lube oil filtration applications, such housings having unfiltered oil plenums (e.g., the unfiltered fluid plenum 218) with such large volumes may be required to meet oil flow and filtration criteria.

In one embodiment, the body 206 includes a cylindrical sleeve 244 and an end cap, formed dish or head 246. The cylindrical sleeve 244 and the head 246 may be fabricated from steel or other suitable material, as described above. In one embodiment, the sleeve 244 is fabricated from steel having at thickness of at least 0.1 inches to accommodate the housing pressure rating. The head 246 and sleeve 244 may be fabricated from a single element of material or may be fastened together in a manner that provides a seal suitable for use over the pressure and temperature range of the filtering apparatus. In one embodiment, the head 246 is continuously welded to the sleeve 244.

The head 246 may be substantially flat or have a domed shape as illustrated in FIG. 2. The head 246 includes an aperture 248 which facilitates sealingly coupling the manifold block assembly 210 to the head 246. In one embodiment, the aperture 248 is formed in the center of the head 246.

The manifold block assembly 210 is disposed in the aperture 248 and sealed to the housing 202 in a manner that provides a seal suitable for use over the pressure and temperature range of the filtering apparatus. The back of the manifold block assembly 210 is exposed to the unfiltered fluid plenum 218 through the aperture 248. In one embodiment, at least a portion of the manifold block assembly 210 is disposed at least partially through the aperture 248 into the unfiltered fluid plenum 218.

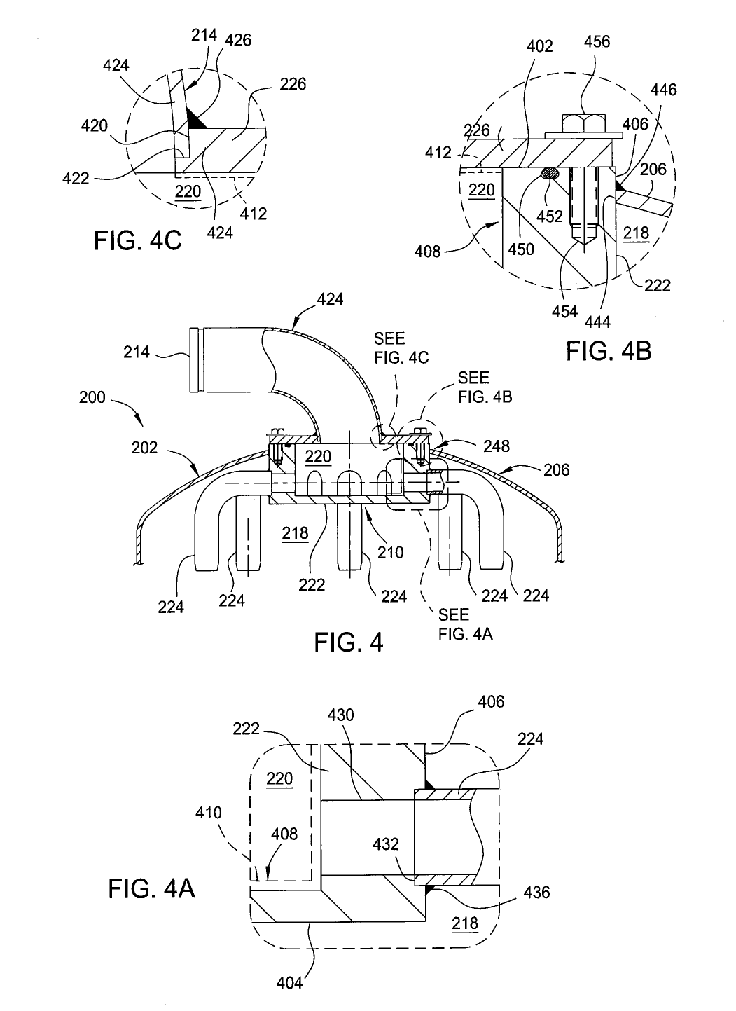

The manifold block assembly 210 includes a manifold block 222, a plurality of index tubes 224 and a manifold cover 226. A second or clean fluid plenum 220 is defined inside the manifold block 222. In the embodiment depicted in FIG. 2, the manifold cover 226 bounds a portion of the clean fluid plenum 220 that is confined inside the manifold block 222. As further described with reference to FIG. 4 below, all surfaces bounding the clean fluid plenum 220 other than the index tubes 224 or other tubing are machined, ground or have surface material removed by some other means to provide smooth clean surfaces for cleaning and inspection. The index tubes 224 extend from the unfiltered fluid plenum 218 partially into the manifold block 222. A passage 228 extends through each index tube 224, fluidly coupling the unfiltered fluid plenum 218 to the second plenum 220 through the manifold block 222. The distal end of the index tube 224 is configured to receive the filter element 204. The index tubes 224 may be fabricated from a material weldable to the housing 202, or other suitable material. Examples of other suitable materials may include, but are not limited to, various metals, plastic, and fiber-reinforced composites. In one embodiment, the index tubes 224 are cold drawn seamless tubing.

An inlet port 216 is formed through the housing 202 to allow fluid to enter the unfiltered fluid plenum 218. The inlet port 216 may be attached to the body 206 or the head 246 or the cover 208. The fluid in the unfiltered fluid plenum 218 passes through the filter elements 204 disposed on the distal end of the index tube 224 and into the passage 228 then finally into the second plenum 220 defined in the manifold block assembly 210. The manifold block assembly 210 has an outlet port 214 formed therethrough to allow the filtered fluid to exit the second plenum 220 and be routed to a downstream apparatus or process. In one embodiment, the outlet port 214 is attached to the manifold cover 226. The inlet and outlet ports 214, 216 may be configured with a connection suitable for coupling the filter apparatus 200 to the fluid conduits utilized in the particular application in which the filter apparatus 200 is to be utilized. In one embodiment, the inlet and outlet ports 214, 216 are configured to be suitable for Victaulic or Marmon type couplings.

FIG. 4 depicts an enlarged partial sectional view of the filter housing illustrating the manifold block assembly 210 in greater detail. The manifold block 222 of the manifold block assembly 210 may be cylindrical in form or alternatively has another geometric shape. The manifold block 222 is generally constructed of material compatible with the temperature, chemistry and pressure of the fluid being filtered, such as described above. In one embodiment, the manifold block 222 is fabricated from steel or other suitable material. Examples of other suitable materials may include, but are not limited to, cast iron, steel, stainless steel, aluminum, plastic, and fiber-reinforced composites. The manifold block 222 includes an outer surface 402, (FIG. 4B) an inner surface 404 (FIG. 4A) and an outer wall 406 (FIG. 4B). A recess 408 is formed in the outer surface 402 of the manifold block 222. The second plenum 220 is at least partially defined by the recess 408. Inside surfaces 410 (FIG. 4A) of the manifold block 222 defining the recess 408 are machined to provide a smooth, clean and contamination free surface. The inside surfaces 410 of the manifold block 222 may also be cleaned after machining to ensure that the inside surfaces 410 in contact with the filtered fluid passing through the second plenum 220 during operation of the filter apparatus 200 are not contaminated by any debris present in the manifold block 222 during fabrication. Additionally, the inside surface 412 (FIG. 4B) of the manifold cover 226 exposed to the second plenum 220 and enclosing the recess 408 may also be machined to facilitate cleaning and inspection to ensure the filtered fluid is not contaminated. In one embodiment, the inside surfaces 410 and/or 412 are machined, ground, bored, reamed, polished or lapped or have surface material removed by some other means to yield a minimum surface finish of about 250 RMS or smoother.

Referring additionally to FIG. 4A, the manifold block 222 includes a plurality of index tube receiving holes 430. The index tube receiving holes 430 may be formed through the outer wall 406 or the inner surface 404 the manifold block 222. Each index tube 224 is sealingly coupled to a respective one of the index tube receiving holes 430. The index tube 224 may be coupled to the index tube receiving hole 430 via a press fit, threaded engagement, brazing, clamping, welding or other suitable method. In the embodiment depicted in FIG. 4, each index tube 224 is coupled to the index tube receiving hole 430 via a weld 436.

In one embodiment, the index tube receiving hole 430 includes a step 432 formed in the portion of the manifold block 222 opposite the recess 408. The step 432 prevents the index tube from being inserted further into hole 430 and prevents weld projections from the weld 436 to penetrate past the step 432 into the exposed part of hole 430. Advantageously, the weld 436 is exposed to the unfiltered fluid plenum 218, in which the unfiltered fluid resides. Thus, any potential contamination associated with the weld 436 and/or weld process is exposed only to the unfiltered fluid within the unfiltered fluid plenum 218, and isolated from the second plenum 220 containing the filtered fluid by the contact between the index tube 224 and the step 432. Additionally, the diameter of the portion of the index tube receiving hole 430 mating with the index tube 224 may be selected to provide a press fit with the index tube 224. The press fit, being on the clean fluid side of the weld 436, provides an additional barrier that substantially prevents contamination associated with the weld 436 and/or weld process from reaching the recess 408, thereby preventing such contamination from becoming entrained in the filtered fluid and exiting the filter apparatus 200.

Referring now to FIGS. 4 and 4B, the outer wall 406 of the manifold block 222 is sealed to the body 206 of the housing 202. The diameter of the outer wall 406 is selected to extend through the aperture 248 defined by a distal end 444 of the body 206. The manifold block 222 is secured to the body 206 such that the index tube receiving holes 430 are within the body 206 while a portion of the outer surface 402 and an upper portion of the outer wall 406 of the manifold block 222 extends to the outside the body 206. In this manner, the manifold block 222 may be readily secured to the body 206 of the housing 202 in a predefined position by a weld 446 or other suitable means. Since the weld 446 is located on the exterior of the body 206 and the exterior of the manifold block 222, the weld 446 is isolated from the second plenum 220 thereby preventing contaminants from becoming entrained in the filtered fluid during operation of the filter apparatus 200. It is contemplated that the manifold block 222 may be sealingly fastened to the body 206 utilizing alternative, suitable methods.

Referring now to FIGS. 4 and 4B, the outer surface 402 of the manifold block 222 includes a seal gland 450. The seal gland 450 accommodates a seal 452 which provides a seal between the manifold cover 226 and the manifold block 222. The seal 452 may be a gasket, o-ring, pour-in-place elastomer or other suitable sealing member. A plurality of threaded holes 454 are provided in a bolt circle radially outward of the seal gland 450 to accommodate securing the cover 226 to the manifold block 222 utilizing a plurality of fasteners 456. It is contemplated that the cover 226 may be secured to the manifold block 222 utilizing alternative, suitable methods.

Referring now to FIGS. 4 and 4C, the cover 226 may additionally include a hole 420 to facilitate forming or attaching the outlet port 214. The hole 420 may include a counter bore 422 on the outside surface of the cover 226 facing away from the recess 408. The counter bore 422 accepts the outlet pipe or tube 424, which forms the outlet port 214 within the manifold cover 226. In one embodiment, the tube 424 is cold drawn seamless tubing. The contact between the outlet pipe 424 and the hole 420 allows the outlet port 214 to be secured to the cover 226 by a weld 426 which is isolated from the second plenum 220 by the counter bore 422. Additionally, the outlet port 214 may be press fit in the hole 420 and/or counter bore 422 to prevent contamination from the weld 426 and/or welding process from reaching the recess 408, thereby preventing potential contamination of the filtered fluid passing through the second plenum 220 and out the outlet port 214. The inside surface 412 of cover 226 could have surface material removed by machining or some other means to give a minimum surface finish of 250 RMS to facilitate cleaning and inspection.

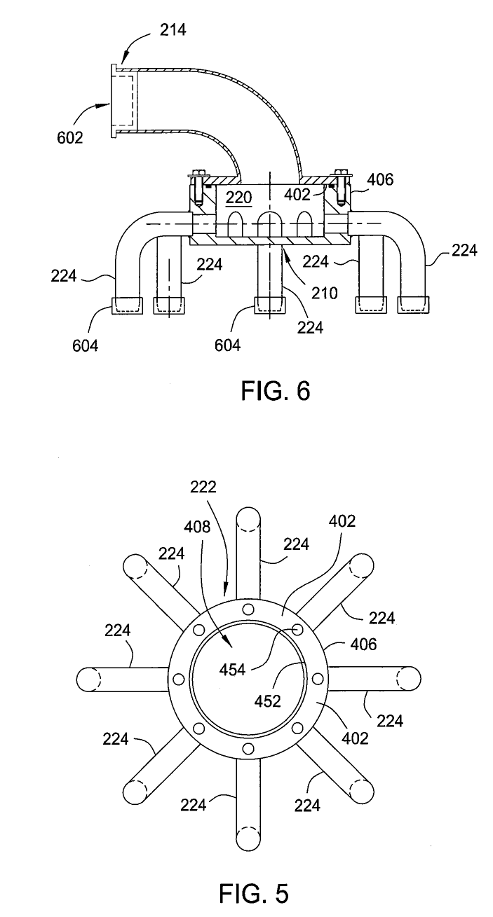

Referring now to FIGS. 2 and 4-5, the index tubes 224 may extend radially outward from the outer wall 406 then bend away from the outer surface 402 in a direction towards the cover 208. In one embodiment, at least some of the index tubes 224 have a bend of about 90 degrees such that a centerline of the passage 228 at the distal end of the index tube 224 is parallel with a centerline of the body 206 while the centerline of the passage 228 at the end of the index tube 224 coupled to the manifold block 222 is perpendicular to the centerline of the body 206. It is contemplated that not all index tubes 224 may have the same angle of bend, length, diameter or other geometry. The index tubes 224 may or may not be equally spaced around the outer wall 406 of the manifold block 222. In one embodiment, at least 2 different configurations of index tubes 224 are utilized, each index tube 224 for mounting a respective filter element 204 to the manifold block 222. In the embodiment depicted in FIG. 5, 8 index tubes 224 are utilized for mounting 8 filter elements 204 to the manifold block 222.

FIG. 6 depicts an embodiment of the manifold block assembly 210 of FIG. 2 illustrated with the recess 408 capped to maintain cleanliness after manufacture of the manifold block assembly 210 and/or housing 202. The recess 408 may by capped covering the outlet port 214 with a outlet barrier 602 which prevents contaminants from entering the recess 408 through the outlet port 214. In one embodiment, the outlet barrier 602 may be a foil or film having a pressure sensitive adhesive securing the outlet barrier 602 to the opening of the fluid passage formed through the outlet port 214. Alternatively, the outlet barrier 602 may be cap or plug pressed onto or into the opening of the fluid passage formed through the outlet port 214. In another embodiment wherein the manifold block assembly 210 is shipped without the manifold cover 226, the outlet barrier 602 may be a foil or film having a pressure sensitive adhesive securing the outlet barrier 602 to the outer surface 402 of the manifold block 222 over the recess 408. Alternatively, the outlet barrier 602 may be cap or plug pressed onto or into the recess 408.

To prevent contaminants from entering the recess through the index tubes 224, an inlet barrier 604 may be disposed over the ends of the index tubes 224 which receive the filter element 204. The inlet barrier 604 may be a foil or film having a pressure sensitive adhesive securing the inlet barrier 604 exterior of the index tube 224 and covering the passage within the index tube 224 which leads to the recess 408. Alternatively, the inlet barrier 604 may be cap or plug pressed onto or into the end of the index tube 224 which receives the filter element 204.

Advantageously, the capped recess 408 allows the manifold block assembly 210 and/or housing 202 to be protected from being contaminated during subsequent fabrication steps, shipping and/or installation of the manifold block assembly 210 into the body 206 of the housing 202 and/or installation of the housing 202 into its final application, such as coupling to the lube oil circuit of a diesel engine. Thus, the superior cleanliness of the surface defining the second plenum which is obtained by removing material and leaving a smooth surface finish are maintained resulting in better filtration results due to reduced risks of contamination as compared to conventional filtration apparatuses.

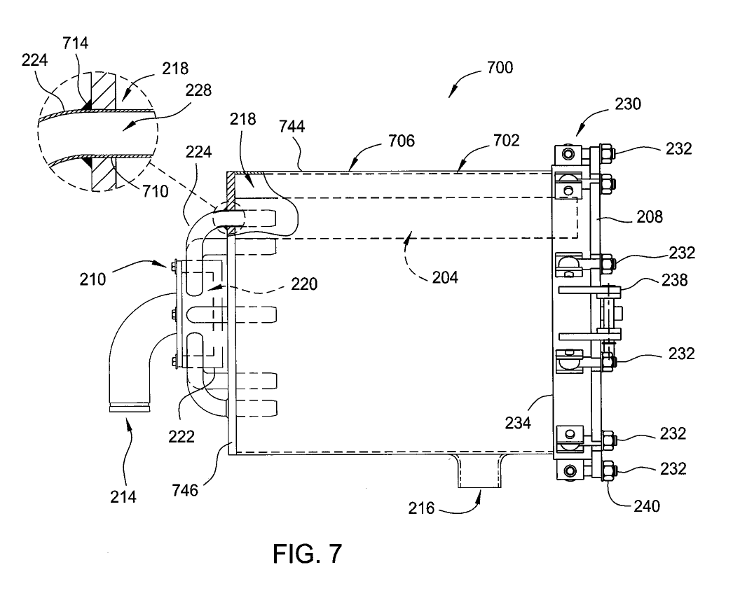

FIG. 7 is a cut-away view of another embodiment of a filter apparatus 700. The filter apparatus 700 is similar in construction relative to the filter apparatus 200 discussed above, except wherein a manifold block 222 of a manifold block assembly 210 is disposed outside of a housing 702 of the filter apparatus 700. In the embodiment depicted in FIG. 7, the housing 702 of the filter apparatus 700 accommodates a plurality of filter elements 204 disposed therein. Only one filter element 204 is shown in the embodiment depicted in FIG. 7 to avoid drawing clutter and promote clarity, but it is contemplated that the housing 702 may be configured to accept any desired number of filter elements 204.

The housing 702 includes a body 706, a cover 208 and the manifold block assembly 210 with its associated index tubes 224 which confine a unfiltered fluid plenum 218 in which the filter elements 204 reside. The body 706 is sealingly coupled to the index tubes 224 by welds or other suitable leak-tight fastening arrangement. The cover 208 is removably coupled to the body 706 by a plurality of securing mechanisms 230 as discussed above with reference to the filter apparatus 200.

The body 706 can be fabricated from steel or other material compatible with the fluid to be filtered at the operational pressure and temperature conditions. In one embodiment, the body 706 has at least one of the volume or pressure ratings discussed above.

In one embodiment, the body 706 includes a cylindrical sleeve 744 and an end cap 746. The cylindrical sleeve 744 and the end cap 746 may be fabricated from steel or other suitable material, as described above. In one embodiment, the end cap 746 is continuously welded to the sleeve 744. In another embodiment, the end cap 746 may be secured to the sleeve 744 by a plurality of securing mechanisms 230.

The end cap 746 may have a domed shape or be substantially flat as illustrated in FIG. 7. The end cap 746 includes plurality of index tube receiving apertures 710 which allows the index tubes 224 of the manifold block assembly 210 to extend through the end cap 746 and into the unfiltered fluid plenum 218 defined within the body 706 of the housing 702. The index tube 224 is secured to the exterior of the end cap 746 by a weld 714.

Advantageously, the weld 714 is exposed to the exterior of the housing 702, thus avoiding contamination of the filtered fluid. Moreover, even if contamination from the weld 714 passes through the index tube receiving aperture 710 formed in end cap 746, the contamination would enter the unfiltered fluid plenum 218, and thereby be isolated from the second plenum 220 by the filter element 204. Thus, any potential contamination associated with the weld 714 and/or weld process is exposed only to the unfiltered fluid within the unfiltered fluid plenum 218, and isolated from the second plenum 220 containing the filtered fluid.

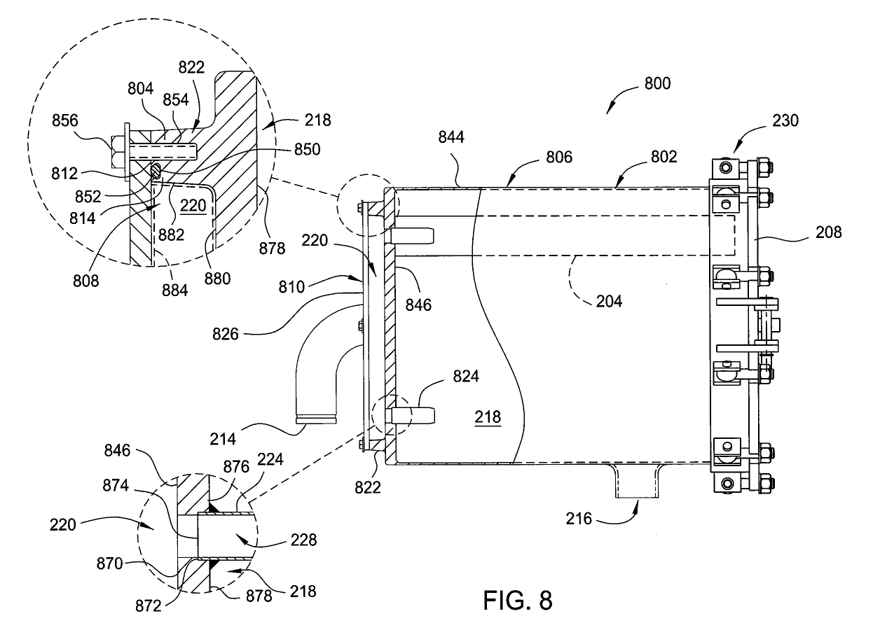

FIG. 8 is a cut-away view of another embodiment of a filter apparatus 800. The filter apparatus 800 is similar in construction relative to the filter apparatuses 200 and 700 discussed above. In the embodiment depicted in FIG. 8, a housing 802 of the filter apparatus 800 accommodates a plurality of filter elements 204 disposed therein. Only one filter element 204 is shown in the embodiment depicted in FIG. 8 to avoid drawing clutter and promote clarity, but it is contemplated that the housing 802 may be configured to accept any desired number of filter elements 204.

The housing 802 includes a body 806, a cover 208 which confine a first or unfiltered fluid plenum 218 in which the filter elements 204 reside. The cover 208 is removably coupled to the body 806 by a plurality of securing mechanisms 230 as discussed above with reference to the filter apparatus 200.

The body 806 can be fabricated from steel or other material compatible with the fluid to be filtered at the operational pressure and temperature conditions. In one embodiment, the body 806 for at least one of the volume or pressure ratings discussed above.

In one embodiment, the body 806 includes a cylindrical sleeve 844 and an end cap 846. The cylindrical sleeve 844 and the end cap 846 may be fabricated from steel or other suitable material, as described above. In one embodiment, the end cap 846 is continuously welded to the sleeve 844. In another embodiment, the end cap 846 may be secured to the sleeve 844 by a plurality of securing mechanisms 230. In the embodiment depicted in FIG. 8, the end cap 846 and sleeve 844 are fabricated from a single unitary member.

The end cap 846 may have a domed shape or be substantially flat as illustrated in FIG. 8. The end cap 846 includes plurality of index tube receiving apertures 870 which allows index tubes 824 to be attached to the end cap. Although only two index tubes 824 are shown in the embodiment of FIG. 8, it is contemplated that more that two index tubes 824 may be utilized as needed to accommodate a desired number of filter elements 204.

Each index tube 824 is sealingly coupled to a respective one of the index tube receiving aperture 870. The index tube 824 may be coupled to the index tube receiving aperture 870 via a press fit, threaded engagement, brazing, clamp, weld or other suitable method. In the embodiment of FIG. 8, the index tube 824 is secured to the end cap 846 by a weld 876.

In one embodiment, the index tube receiving aperture 870 includes a step 872 that abuts to an end 874 of the index tube 224 so that weld projections from the attaching and sealing weld 876 can not reach the clean fluid plenum 220. Thus, any potential contamination associated with the weld 876 and/or weld process is exposed only to the unfiltered fluid within the unfiltered fluid plenum 218, and isolated from the second plenum 220 containing the filtered fluid. Additionally, the diameter of the portion of the index tube receiving aperture 870 receiving the index tube 824 may be selected to provide a press fit with the index tube 824. The press fit, being on the clean fluid side of the weld 876, provides an additional barrier that substantially prevents contamination associated with the weld 876 and/or weld process from reaching the clean fluid plenum 220, thereby preventing such contamination from becoming entrained in the filtered fluid and exiting the filter apparatus 800.

In the embodiment depicted in FIG. 8, a clean fluid manifold 810 of the body 806 is partially incorporated into the end cap 846. The clean fluid manifold 810 includes a manifold cover 826 and an outer containment 822. The manifold cover 826 may be constructed as described above. The outer containment 822 may be an integral part of the end cap 846 or sealingly fastened thereto, for example by a continuous weld. In the embodiment depicted in FIG. 8, the end cap 846 is cast to integrally include the outer containment 822. The outer containment 822 includes an outer surface 812, an outer wall 804 and an inner wall 814.

The outer wall 804 confines recess 808 in which the second plenum 220 is confined. A bottom surface 880 of the recess 808 may be comprised by portion of the end cap 846 facing away from the first plenum 218. An inner surface 882 of the wall 814 and the bottom surface 880 of the recesses 808, which comprise the inside surfaces of the recess 808, are machined or have surface material removed by another suitable means to provide a smooth, clean and contamination free surface for the second plenum 220. Additionally, an inside surface 884 of the manifold cover 226 exposed to the second plenum 220 and enclosing the recess 808 may also be machined to facilitate cleaning and inspection to ensure the filtered fluid is not contaminated. In one embodiment, the inside surfaces 882, 880 and/or 884 are machined to a surface finish of about 250 RMS or smoother. The inside surfaces 882, 880 and 884 of the clean fluid manifold may also be cleaned after machining to ensure that the inside surfaces 882, 880 and 884 in contact with the filtered fluid passing through the second plenum 220 during operation of the filter apparatus 800 are not contaminated by any debris present in the clean fluid manifold during fabrication.

The outer surface 812 of the outer containment 822 includes a seal gland 850. The seal gland 850 accommodates a seal 852 which provides a seal between the manifold cover 826 and the outer containment 822. The seal 852 may be a gasket, o-ring, pour-in-place elastomer or other suitable sealing member. A plurality of threaded holes 854 are provided in a bolt circle radially outward of the seal gland 850 to accommodate securing the cover 826 to the outer containment 822 utilizing a plurality of fasteners 856. It is contemplated that the cover 826 may be secured to the outer containment 822 utilizing alternative, suitable methods.

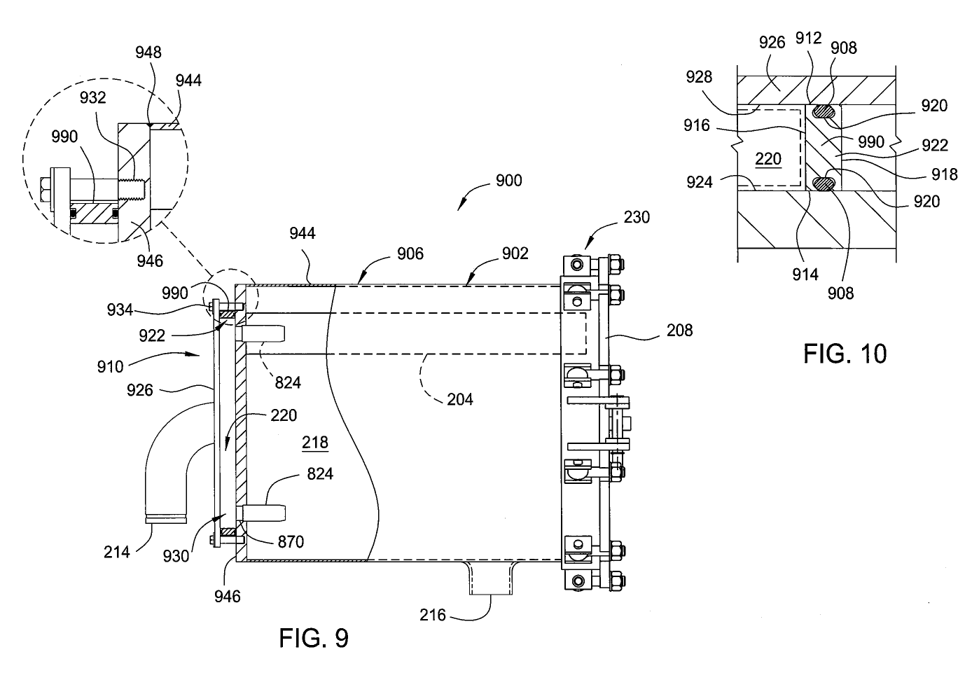

FIG. 9 is a cut-away view of another embodiment of a filter apparatus 900. The filter apparatus 900 is similar in construction relative to the filter apparatus 800 discussed above. In the embodiment depicted in FIG. 9, a housing 902 of the filter apparatus 900 accommodates a plurality of filter elements 204 disposed therein. Only one filter element 204 is shown in the embodiment depicted in FIG. 9 to avoid drawing clutter and promote clarity, but it is contemplated that the housing 902 may be configured to accept any desired number of filter elements 204.

The housing 902 includes a body 906, a cover 208 which confine a unfiltered fluid plenum 218 in which the filter elements 204 reside. The cover 208 is removably coupled to the body 906 by a plurality of securing mechanisms 230 as discussed above with reference to the filter apparatus 200.

The body 906 can be fabricated from steel or other material compatible with the fluid to be filtered at the operational pressure and temperature conditions. In one embodiment, the body 906 is suitable for at least one of the volume or pressure ratings discussed above.

In one embodiment, the body 906 includes a cylindrical sleeve 944 and an end cap 946. The cylindrical sleeve 944 and the end cap 946 may be fabricated from steel or other suitable material, as described above. In the embodiment depicted in FIG. 9, the end cap 946 is continuously welded to the sleeve 944 by a weld 948. In another embodiment, the end cap 946 may be secured to the sleeve 944 by a plurality of securing mechanisms 230. In yet another embodiment, the end cap 946 and sleeve 944 are fabricated from a single unitary member.

The end cap 946 may have a domed shape or be substantially flat as illustrated in FIG. 9. The end cap 946 includes a plurality of index tube receiving apertures 870 which allows index tubes 824 to be connected to the end cap 946 and into the unfiltered fluid plenum 218 defined within the body 906 of the housing 902. The coupling of the index tubes 824 to the index tube receiving apertures 870 may be made as described above in reference to FIG. 8. Although only two index tubes 824 are shown in the embodiment of FIG. 9, it is contemplated that more that two index tubes 824 may be utilized as needed to accommodate a desired number of filter elements 204.

In the embodiment depicted in FIG. 9, a clean fluid manifold 910 of the body 906 is partially incorporated into the end cap 946 which confines a second or clean fluid plenum 220. The clean fluid manifold 910 includes a manifold cover 926 and a containment ring 922. The manifold cover 926 may be constructed as described above. The containment ring 922 may be a separate element, or the containment ring 922 may be comprised of a portion of the end cap 946 or the cover 926. In the embodiment of FIG. 9, the second plenum 220 is confined by the cover 926, the containment ring 922 and a bottom surface, the bottom surface comprised by a portion of the end cap 946.

Additionally referring to FIG. 10, the ring 922 is fabricated from steel or other material compatible with the fluid being filtered at operating conditions. The ring 992 includes an outer surface 912, an inner surface 914, an inner surface 916 and an outer surface 918. The surfaces 912 and 914 include a seal gland 920 that accommodates a seal 908 for sealing the ring 922 to the manifold cover 926 and to the end cap 946 to confine the second plenum 220 circumscribed by the ring 922. While the seal glands are shown in FIG. 10 to be incorporated into the containment ring 922 they could also be incorporated into the end cap 946 and/or the clean fluid manifold cover 926 instead of in the containment ring.

The inner surface 916 of the ring 922 and the outer surface 924 of the end cap 946 bounding a recess 930 in which the second plenum 220 is machined, or otherwise has surface material removed to provide a smooth, clean and contamination free surface. A lower surface 928 of the manifold cover 926 exposed to the second plenum 220 and enclosing the recess 930 may also be machined to ensure the filtered fluid is not contaminated. In one embodiment, the surfaces 916, 924 and/or 928 are machined, as indicated by dashed line 990, to a surface finish of about 250 RMS or smoother.

The surfaces 916, 924 and/or 928 may also be cleaned after machining to ensure that the inside surfaces 916, 924 and 928 in contact with the filtered fluid passing through the second plenum 220 during operation of the filter apparatus 900 are not contaminated by any debris present in the recess 930 during fabrication.

The end cap 946 additionally includes a plurality of blind threaded holes 932 which are provided in a bolt circle radially outward of the containment ring 922 to accommodate securing the manifold cover 926 to the end cap 946 utilizing a plurality of fasteners 934. It is contemplated that the manifold cover 926 may be secured to the end cap 946 utilizing alternative, suitable methods.

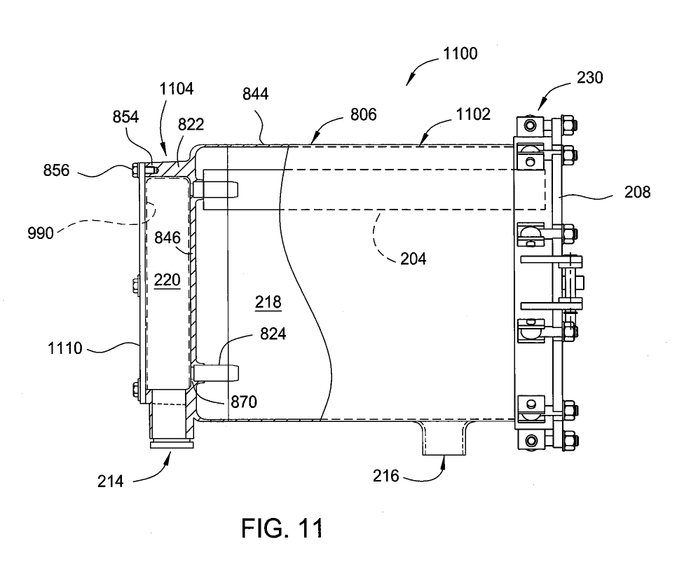

FIG. 11 is a cut-away view of another embodiment of a filter apparatus 1100. The filter apparatus 1100 is similar in construction relative to the filter apparatuses 800 and 900 discussed above, except that an outlet port 214 of the filter apparatus 1100 is not disposed through or on a clean fluid manifold cover 1110 enclosing a second plenum 220. In the embodiment depicted in FIG. 11, a housing 1102 of the filter apparatus 1100 includes a containment ring 1104 that accommodates the outlet port 214. The portion of the containment ring 1104 that accommodates the outlet port 214 may be a separate ring, as described above referring to the ring 922, or an integral part of an end cap of the housing 1102, as described above referring to the outer wall 804. When the interior of the outlet port is of a construction that is susceptible to contamination either by reason of material properties or fabrication methods the interior surfaces which can contact flowing filtered fluid can be machined or have surface material removed by some other means to assure a smooth surface finish which can be readily cleaned and inspected for cleanliness.

The other components of the filter apparatus 1100 are numbered to refer to the components described above, and have been omitted here for the sake of brevity.

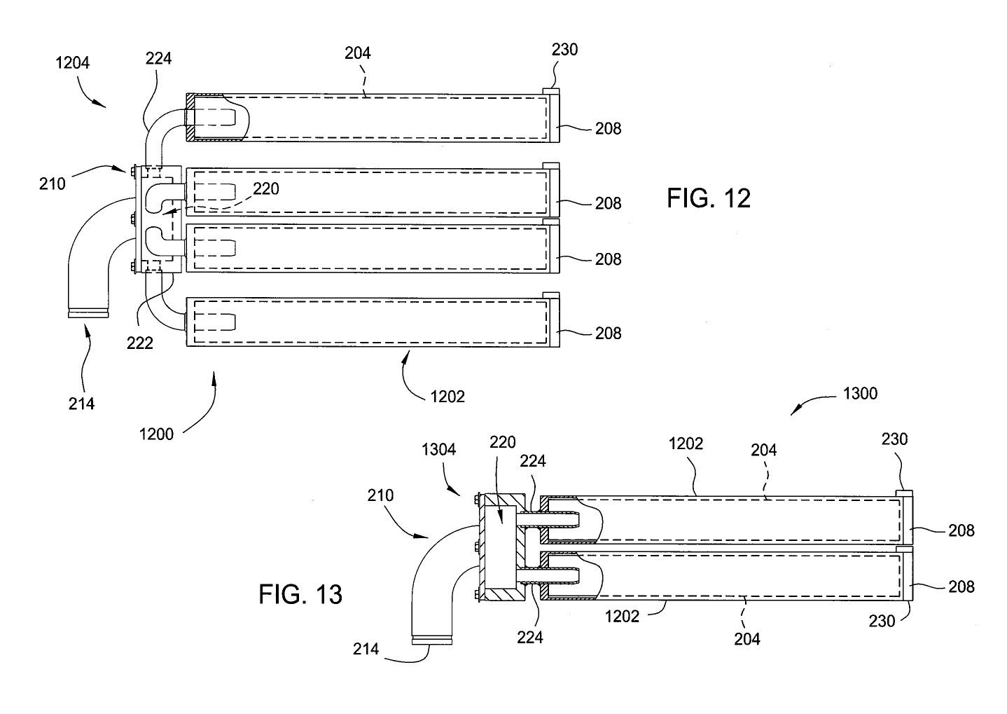

FIGS. 12 and 13 respectively depict additional embodiments of the present invention wherein a clean fluid manifold is utilized with a plurality of filter housings. In the embodiments depicted in FIG. 12, a filter apparatus 1200 includes a clean fluid manifold 1204 coupled to a plurality of filter housings 1202 by index tubes 224. The clean fluid manifold 1204 has an internal clean fluid plenum 220, the plenum having bounding surfaces, other than tubing, which having been machined or otherwise having surface material removed to provide a smooth, clean and contamination free surface for contact with the filtered fluid. Each filter housing 1202 contains an unfiltered fluid plenum receiving one or more filter elements 204 which respectfully engages an index tube 224 that projects through a closed end of the filter housing. A filter apparatus 1300 depicted in FIG. 13 is similarly constructed, having a clean fluid manifold 1304 with internal clean fluid plenum 220. The index tubes 224 utilized in the apparatus 1200, 1300 may be straight and approximately parallel to each other where the index tubes enter the clean fluid manifold 1204 through its end-cap as depicted in FIG. 13, or the index tubes 224 may be bent to enter the clean fluid manifold 1304 through its outer periphery as shown in FIG. 12. In both embodiments, the measures taken for achieving and maintaining cleanliness of the clean plenum bounding surfaces in contact with filtered fluid remain unchanged.

Thus, embodiments for a housing for a filter apparatus has been described above which is suitable for use at pressure ratings over of at least 11 psig while maintaining the internal surfaces of the second plenum, e.g., the plenum collecting the fluid filtered by the filter elements, free from contamination. Advantageously, the inventive filter housing allows for the use of welding during fabrication while isolating the weld and contamination associated with the welding process from the second clean plenum. In at least one embodiment, all surfaces in contact with the filtered fluid other than cold drawn seamless tubing that may be used for index tubes, may be machined, ground or have surface material removed by some other means to yield a minimum surface finish of 250 RMS to facilitate cleaning and inspection. Moreover, there are no exposed as-deposited welds in the second plenum which collects the filtered fluid, and where welds are used in the interface between the first and second plenums of the housing, the welds are made from the side of the housing exposed to the first plenum with a physical barrier such as a tight fit or a step or shoulder in a bore to prevent weld projections from reaching the second plenum of the housing wherein the filtered fluid is collected.

In some embodiments wherein welds are used on an interface between the second plenum and the first plenum of the filter housing or on the envelope of the second plenum, and where it is not possible or practical to employ a physical barrier to prevent weld projections from reaching the clean plenum, the surfaces defining the recess in which the second plenum is defined may be welded and the clean surfaces including the filler weld may be machined or ground flush to a minimum surface finish of 250 RMS to facilitate cleaning and inspection.

Embodiments of the inventive housing additionally allow the second plenum to be readily inspected. For example, with the manifold cover removed, all surfaces of the recess bounding the second chamber of the filter housing other than the inside of bent tubing are accessible for visual inspection by direct line of sight, eliminating the need for mirrors and optical scopes generally required to inspect conventional housings. This also allows the recess of the housing to advantageously be cleaned, inspected and hermetically sealed by a barrier in a clean area prior to incorporation into the complete filter housing. In some embodiments, the barrier seal does not need to be broken until the housing is connected to its process and the filter elements installed.

Although various embodiments which incorporate the teachings of the present invention have been shown and described in detail herein, those skilled in the art can readily devise many other varied embodiment that still incorporate these teachings.

What is claimed is:

1. A filter housing comprising:
a body having a first plenum defined therein;
a cover plate coupled to the body and openable to allow main access to the first plenum;
an inlet port in fluid communication with the first plenum, the inlet port defined through one of the body or cover; and
a clean fluid manifold assembly coupled to the body, the manifold assembly comprising:
a manifold block having a recess defining a second plenum, wherein surfaces of the recess have been machined to provide smooth clean surfaces for cleaning and inspection;
a manifold cover enclosing the recess;
a plurality of index tubes having a first end coupled to the manifold block and a second end extending into the first plenum, the second end of each index tube configured to engage with a filter element; and
an outlet port in fluid communication with the second plenum, the outlet port defined through one of the manifold block or manifold cover.

2. The filter housing of claim 1, wherein the surfaces of the clean fluid recess have a surface finish of about 250 RMS or smoother.

3. The filter housing of claim 1, wherein the body is secured to the clean fluid manifold by a weld, wherein the weld is isolated from the second plenum and secures an exterior of the clean fluid manifold to the body.

4. The filter housing of claim 1, wherein the clean fluid manifold further comprises:
index tube receiving holes having a step exposed to the first plenum, the step sized to abut the end of the index tube to prevent weld projections from the weld between the index tube and manifold from reaching the clean fluid recess.

5. The filter housing of claim 4, wherein the index tube is press fit into the index tube receiving hole.

6. The filter housing of claim 1, wherein any welds that can come into contact with fluid within the second plenum have surface material removed to make an exposed surface of the weld topographically consistent with adjoining surfaces of the second plenum, and wherein both the weld and the adjoining surfaces have a surface finish of 250 RMS or better.

7. A filter housing comprising:
a sleeve at least partially bounding a first plenum;
an end cap coupled to the sleeve, the end cap having a first side exposed to the first plenum and a second side exposed to a second plenum, the second side of the end cap having a minimum surface finish of about 250 RMS or smoother;
a cover plate coupled to the sleeve and openable to allow access to the first plenum, the cover plate, end cap and sleeve defining a body having an internal diameter of at least 6 inches and a pressure rating of at least 11 psig;
an inlet port in fluid communication with the first plenum, the inlet port defined through one of the sleeve or cover or rear end cap;
a manifold cover enclosing the second plenum;
a plurality of index tubes providing a fluid passage between the first plenum and the second plenum, each index tube having a first end coupled to the end cap and a second end extending into the first plenum, the second end of the index tube configured to engage with a filter element; and
an outlet port in fluid communication with the second plenum.

8. The filter housing of claim 7 further comprising:
a ring circumscribing the second plenum, the ring having a surface exposed to the clean fluid plenum having a minimum surface finish of about 250 RMS or smoother, wherein the ring and the end cap are fabricated from a single element of material.

9. The filter housing of claim 8, wherein the ring is separate and is sealingly coupled to the end cap.

10. The filter housing of claim 8, wherein the outlet port extends through the ring.

11. The filter housing of claim 7, wherein the surface of the manifold cover in contact with the filtered fluid is finished to about 250 RMS or smoother.

12. The filter housing of claim 7, wherein the index tube is secured to the end cap by a weld, wherein the weld is isolated from the second plenum.

13. The filter housing of claim 7, wherein the end cap of the clean fluid manifold further comprises:
an index tube receiving hole having a step exposed to the first plenum, the step sized to abut the end of the index tube so that weld projections from the weld between the index tube and the manifold can not reach the clean fluid recess.

14. The filter housing of claim 7, wherein any welds that can come into contact with fluid within the second plenum have surface material removed to make an exposed surface of the weld topographically consistent with adjoining surfaces of the second plenum, and wherein both the weld and the adjoining surfaces have a surface finish of 250 RMS or better.

15. A filter housing comprising:
a body connected to a housing by index tubes, the body containing a clean recess and the housing containing a unfiltered fluid plenum, the index tubes coupled to the housing by welds that are made outside the clean recess and can not come into contact with fluid disposed in the clean recess.

16. The filter housing of claim 15, wherein any welds that can come into contact with fluid within the second plenum have surface material removed to make an exposed surface of the weld topographically consistent with adjoining surfaces of the second plenum, and wherein both the weld and the adjoining surfaces have a surface finish of 250 RMS or better.

17. The filter housing of claim 16, wherein the all internal surfaces of the clean fluid recess other than tubing that can come into contact with fluid within the clean fluid recess have surface material removed to provide a minimum surface finish of 250 RMS or better.

18. A filter assembly comprising:
a plurality of separate filter housings coupled to a clean fluid manifold through a plurality of index tubes, the clean fluid manifold having internal surfaces removed to provide a clean surface with a surface finish of about 250 RMS or better.

19. The filter housing assembly of claim 18, wherein any welds that can come into contact with fluid within the second plenum have surface material removed to make an exposed surface of the weld topographically consistent with adjoining surfaces of the second plenum, and wherein both the weld and the adjoining surfaces have a surface finish of 250 RMS or better.

20. A method of assembling a filter housing having an assembly comprising of a clean fluid manifold and a plurality of index tubes, the method comprising:
machining surfaces of a clean fluid recess formed in the clean fluid manifold that are designed for exposure to the filtered fluid during use;
cleaning and inspecting the machined surfaces of the assembly;
sealing the clean fluid recess and index tubes of the inspected assembly to prevent contamination prior to incorporation into the filter housing; and
unsealing the clean fluid recess and index tubes after incorporation of the assembly into the filter housing.
